(19) United States
(12) Patent Application Publication
(10) Pub. No.: US 2024/0292434 A1
(43) Pub. Date: Aug. 29, 2024

(54) METHOD FOR NR SIDELINK AND LTE SIDELINK CO-CHANNEL COEXISTENCE

(71) Applicant: QUALCOMM Incorporated, San Diego, CA (US)

(72) Inventors: Tien Viet Nguyen, Bridgewater, NJ (US); Sourjya Dutta, San Diego, CA (US); Gabi Sarkis, San Diego, CA (US); Ahmed Elshafie, San Diego, CA (US); Kapil Gulati, Belle Mead, NJ (US); Shuanshuan Wu, San Diego, CA (US)

(21) Appl. No.: 18/175,336

(22) Filed: Feb. 27, 2023

(51) Int. Cl. H04W 72/40; H04W 72/0446; H04W 72/542

(52) U.S. Cl. CPC H04W 72/40; H04W 72/0446; H04W 72/542; H04W 88/06

(57) ABSTRACT

Methods, systems, and devices for wireless communications are described. The techniques described herein relate to new radio (NR) sidelink and long-term evolution (LTE) sidelink co-channel coexistence for stand-alone NR user equipment. A user equipment (UE) identifies a resource pattern for a set of resources for sidelink communications, the set of resources including a first subset of resources associated with a first radio access technology (RAT) (e.g., LTE) and a second subset of resources associated with a second RAT (e.g., 5G NR). The UE performs a channel busy ratio (CBR) measurement for a resource of the set of resources. The UE adjusts the resource pattern for the set of resources based on the CBR measurement.

### FIELD OF TECHNOLOGY

The following relates to wireless communications, including a method for new radio (NR) sidelink and Long Term Evolution (LTE) sidelink co-channel coexistence for stand-alone NR user equipment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support method for new radio (NR) sidelink and Long Term Evolution (LTE) sidelink co-channel coexistence. An NR user equipment (UE), such as a 5G NR UE, may identify LTE channel occupancy by measuring the channel busy ratio (CBR) for one or more resources (e.g. slots). A UE may identify a pattern of resources, the pattern including a first set of resources dedicated for a second radio access technology (e.g., 5G NR) and a second set of resources dedicated for a first radio access technology (e.g., LTE). The UE may perform a CBR measurement for a resource of the resource pattern (e.g., a slot of a slot pattern), and adjust the resource pattern based on the CBR measurement. The UE may perform the CBR measurement on a resource dedicated for LTE, for example, to determine whether resources dedicated for LTE are being used. As another example, the UE may perform a CBR measurement in a resource dedicated for 5G NR to determine if collisions are occurring on 5G NR resources. In some cases, the UE may perform the CBR measurements on both dedicated LTE and 5G NR resources, and may adjust the resource pattern accordingly. The UE may share the results of the CBR measurement and/or the adjusted resource pattern with other UEs using sidelink inter-coordination messages, and accordingly other UEs may also schedule 5G NR sidelink communications in resources with a low likelihood of collision with LTE communications.

A method for wireless communications at a user equipment (UE) is described. The method may include identifying a resource pattern for a set of resources for sidelink communications, the set of resources including a first subset of resources associated with a first radio access technology and a second subset of resources associated with a second radio access technology, performing a CBR measurement for a resource of the set of resources, and adjusting the resource pattern for the set of resources based on the CBR measurement.

An apparatus for wireless communications at a UE is described. The apparatus may include a processor, memory coupled with the processor, and instructions stored in the memory. The instructions may be executable by the processor to cause the apparatus to identify a resource pattern for a set of resources for sidelink communications, the set of resources including a first subset of resources associated with a first radio access technology and a second subset of resources associated with a second radio access technology, perform a CBR measurement for a resource of the set of resources, and adjust the resource pattern for the set of resources based on the CBR measurement.

Another apparatus for wireless communications at a UE is described. The apparatus may include means for identifying a resource pattern for a set of resources for sidelink communications, the set of resources including a first subset of resources associated with a first radio access technology and a second subset of resources associated with a second radio access technology, means for performing a CBR measurement for a resource of the set of resources, and means for adjusting the resource pattern for the set of resources based on the CBR measurement.

A non-transitory computer-readable medium storing code for wireless communications at a UE is described. The code may include instructions executable by a processor to identify a resource pattern for a set of resources for sidelink communications, the set of resources including a first subset of resources associated with a first radio access technology and a second subset of resources associated with a second radio access technology, perform a CBR measurement for a resource of the set of resources, and adjust the resource pattern for the set of resources based on the CBR measurement.

In some examples of the method, apparatuses, and non-transitory computer-readable medium described herein, communicating, with a second UE, a sidelink message in one of the second subset of resources using the second radio access technology in accordance with the adjusted resource pattern.

In some examples of the method, apparatuses, and non-transitory computer-readable medium described herein, performing the CBR measurement may include operations, features, means, or instructions for performing the CBR measurement in a resource of the first subset of resources associated with the first radio access technology.

In some examples of the method, apparatuses, and non-transitory computer-readable medium described herein, performing the CBR measurement may include operations, features, means, or instructions for performing the CBR measurement in a resource of the second subset of resources associated with the second radio access technology.

Some examples of the method, apparatuses, and non-transitory computer-readable medium described herein may further include operations, features, means, or instructions for performing a second CBR measurement for a second resource of the set of resources, the second resource included within the second subset of resources associated with the second radio access technology, where the resource may be included within the first subset of resources associated with the first radio access technology, and where adjusting the resource pattern further includes adjusting the resource pattern based on the second CBR measurement.

In some examples of the method, apparatuses, and non-transitory computer-readable medium described herein, the first radio access technology includes an LTE technology and the second radio access technology includes a 5G NR technology.

Some examples of the method, apparatuses, and non-transitory computer-readable medium described herein may further include operations, features, means, or instructions for transmitting, to a second UE, a message indicating the adjusted resource pattern.

In some examples of the method, apparatuses, and non-transitory computer-readable medium described herein, communicating, with the second UE, one or more sidelink messages in one or more resources of the second subset of resources using the second radio access technology in accordance with the adjusted resource pattern.

In some examples of the method, apparatuses, and non-transitory computer-readable medium described herein, adjusting the resource pattern may include operations, features, means, or instructions for adjusting a ratio of resources between the first subset of resources and the second subset of resources.

In some examples of the method, apparatuses, and non-transitory computer-readable medium described herein, adjusting the resource pattern may include operations, features, means, or instructions for adjusting the resource pattern based on the CBR measurement satisfying a threshold.

Some examples of the method, apparatuses, and non-transitory computer-readable medium described herein may further include operations, features, means, or instructions for determining the threshold based on an amount of traffic associated with the second radio access technology.

A method for wireless communications at a UE is described. The method may include identifying a resource pattern for a set of resources for sidelink communications, the set of resources including a first subset of resources associated with a first radio access technology and a second subset of resources associated with a second radio access technology, performing a CBR measurement for a resource of the set of resources, and adjusting the resource pattern for the set of resources based on the CBR measurement.

An apparatus for wireless communications at a UE is described. The apparatus may include a processor, memory coupled with the processor, and instructions stored in the memory. The instructions may be executable by the processor to cause the apparatus to identify a resource pattern for a set of resources for sidelink communications, the set of resources including a first subset of resources associated with a first radio access technology and a second subset of resources associated with a second radio access technology, perform a CBR measurement for a resource of the set of resources, and adjust the resource pattern for the set of resources based on the CBR measurement.

Another apparatus for wireless communications at a UE is described. The apparatus may include means for identifying a resource pattern for a set of resources for sidelink communications, the set of resources including a first subset of resources associated with a first radio access technology and a second subset of resources associated with a second radio access technology, means for performing a CBR measurement for a resource of the set of resources, and means for adjusting the resource pattern for the set of resources based on the CBR measurement.

A non-transitory computer-readable medium storing code for wireless communications at a UE is described. The code may include instructions executable by a processor to identify a resource pattern for a set of resources for sidelink communications, the set of resources including a first subset of resources associated with a first radio access technology and a second subset of resources associated with a second radio access technology, perform a CBR measurement for a resource of the set of resources, and adjust the resource pattern for the set of resources based on the CBR measurement.

Some examples of the apparatus may include means for communicating, with a second UE, a sidelink message in one of the second subset of resources using the second radio access technology in accordance with the adjusted resource pattern.

In some examples of the method, apparatuses, and non-transitory computer-readable medium described herein, performing the CBR measurement may include operations, features, means, or instructions for performing the CBR measurement in a resource of the first subset of resources associated with the first radio access technology.

In some examples of the method, apparatuses, and non-transitory computer-readable medium described herein, performing the CBR measurement may include operations, features, means, or instructions for performing the CBR measurement in a resource of the second subset of resources associated with the second radio access technology.

Some examples of the apparatus may include means for performing a second CBR measurement for a second resource of the set of resources, the second resource included within the second subset of resources associated with the second radio access technology, where the resource may be included within the first subset of resources associated with the first radio access technology, and where adjusting the resource pattern further includes adjusting the resource pattern based on the second CBR measurement.

In some examples of the method, apparatuses, and non-transitory computer-readable medium described herein, the first radio access technology includes a long-term evolution (LTE) technology and the second radio access technology includes a fifth generation new radio (5G NR) technology.

Some examples of the apparatus may include means for transmitting, to a second UE, a message indicating the adjusted resource pattern.

A method for wireless communications at a UE is described. The method may include identifying a resource pattern for a set of resources for sidelink communications, the set of resources including a first subset of resources associated with a first radio access technology and a second subset of resources associated with a second radio access technology, performing a CBR measurement for a resource of the set of resources, and adjusting the resource pattern for the set of resources based on the CBR measurement.

An apparatus for wireless communications at a UE is described. The apparatus may include a processor, memory coupled with the processor, and instructions stored in the memory. The instructions may be executable by the processor to cause the apparatus to identify a resource pattern for a set of resources for sidelink communications, the set of resources including a first subset of resources associated with a first radio access technology and a second subset of resources associated with a second radio access technology, perform a CBR measurement for a resource of the set of resources, and adjust the resource pattern for the set of resources based on the CBR measurement.

Another apparatus for wireless communications at a UE is described. The apparatus may include means for identifying a resource pattern for a set of resources for sidelink communications, the set of resources including a first subset of resources associated with a first radio access technology and a second subset of resources associated with a second radio access technology, means for performing a CBR measurement for a resource of the set of resources, and means for adjusting the resource pattern for the set of resources based on the CBR measurement.

A non-transitory computer-readable medium storing code for wireless communications at a UE is described. The code may include instructions executable by a processor to identify a resource pattern for a set of resources for sidelink communications, the set of resources including a first subset of resources associated with a first radio access technology and a second subset of resources associated with a second radio access technology, perform a CBR measurement for a resource of the set of resources, and adjust the resource pattern for the set of resources based on the CBR measurement.

### BRIEF DESCRIPTION OF THE DRAWINGS

FIG. 1 illustrates an example of a wireless communications system that supports a method for new radio (NR) sidelink and Long Term Evolution (LTE) sidelink co-channel coexistence in accordance with one or more aspects of the present disclosure.

FIG. 2 illustrates an example of another wireless communications system that supports a method for NR sidelink and LTE sidelink co-channel coexistence in accordance with one or more aspects of the present disclosure.

FIG. 3A illustrates an example of a resource occupancy diagram that supports a method for NR sidelink and LTE sidelink co-channel coexistence in accordance with one or more aspects of the present disclosure.

FIG. 3B illustrates an example of sidelink feedback resources that support a method for NR sidelink and LTE sidelink co-channel coexistence in accordance with one or more aspects of the present disclosure.

FIG. 4 illustrates an example of a process flow that supports a method for NR sidelink and LTE sidelink co-channel coexistence in accordance with one or more aspects of the present disclosure.

FIGS. 5 and 6 illustrate block diagrams of devices that support method for NR sidelink and LTE sidelink co-channel coexistence in accordance with one or more aspects of the present disclosure.

FIG. 7 illustrates a block diagram of a communications manager that supports a method for NR sidelink and LTE sidelink co-channel coexistence in accordance with one or more aspects of the present disclosure.

FIG. 8 illustrates a diagram of a system including a device that supports a method for NR sidelink and LTE sidelink co-channel coexistence in accordance with one or more aspects of the present disclosure.

FIGS. 9 and 10 illustrate flowcharts showing methods that support method for NR sidelink and LTE sidelink co-channel coexistence in accordance with one or more aspects of the present disclosure.

### DETAILED DESCRIPTION

In some wireless communications systems, multiple radio access technologies (RAT)s may use the same set of time and frequency resources. For example, a first RAT may be a Long Term Evolution (LTE) technology and a second RAT may be a fifth generation (5G) new radio (NR) technology. A user equipment (UE) may include circuitry or modules for communicating using one RAT but not the other. For example, a 5G NR UE may not include an LTE module. As another example, a 5G NR UE may include an LTE module, but may not include an interface between the NR and LTE modules. Such a 5G NR UE (e.g., the second RAT UE) may be unable to obtain resource usage information for LTE (the first RAT). In sidelink mode 2, where UEs autonomously schedule communications in sidelink resources, such a 5G NR UE may schedule communications without knowledge of LTE scheduling assignments, which may result in collisions and interference between 5G NR and LTE sidelink communications.

A 5G NR UE may estimate LTE channel occupancy by measuring a channel busy ratio (CBR) in a sidelink resource. For slots, a CBR measured in slot n is defined as the portion of subchannels in the resource pool where a sidelink received signal strength indicator (RSSI) measured by the UE 115 exceeds a threshold measured (e.g., sensed) over a CBR measurement window (e.g., n−a, n−1, wherein a is equal to 100 or a product of 100 and 2 micro slots (2μ)t, according to higher layer parameter).

A UE may identify a pattern of resources (e.g., pattern of resources or a resource pattern), the pattern including a first set of resources dedicated for 5G NR (the second RAT) and a second set of resources dedicated for LTE (the first RAT). The UE may perform a CBR measurement for a resource of the resource pattern (e.g. a slot of a slot pattern), and adjust the resource pattern based on the CBR measurement. For example, if the CBR measurement indicates a high LTE channel occupancy, the UE may increase the quantity of resources dedicated for LTE and correspondingly decrease the quantity of resources dedicated for 5G NR. Similarly, if the CBR measurement indicates a low LTE channel occupancy, the UE may increase the quantity of resources dedicated for 5G NR and correspondingly decrease the quantity of resources dedicated for LTE. The UE may perform the CBR measurement on a resource dedicated for LTE, for example, to determine whether resources dedicated for LTE are being used. As another example, the UE may perform a CBR measurement in a resource dedicated for 5G NR to determine whether resources dedicated for 5G NR are being used. In some cases, the UE may perform the CBR measurements on both dedicated LTE and 5G NR resources, and may adjust the resource pattern accordingly. The UE may share the results of the CBR measurement and/or the adjusted resource pattern with other UEs using sidelink inter-coordination messages, and accordingly other UEs may also schedule 5G NR sidelink communications in resources with a low likelihood of collision with LTE communications.

Aspects of the disclosure are initially described in the context of wireless communications systems. Aspects of the disclosure are further illustrated by and described with reference to resource occupancy diagrams, process flows, apparatus diagrams, system diagrams, and flowcharts that relate to method for NR sidelink and LTE sidelink co-channel coexistence.

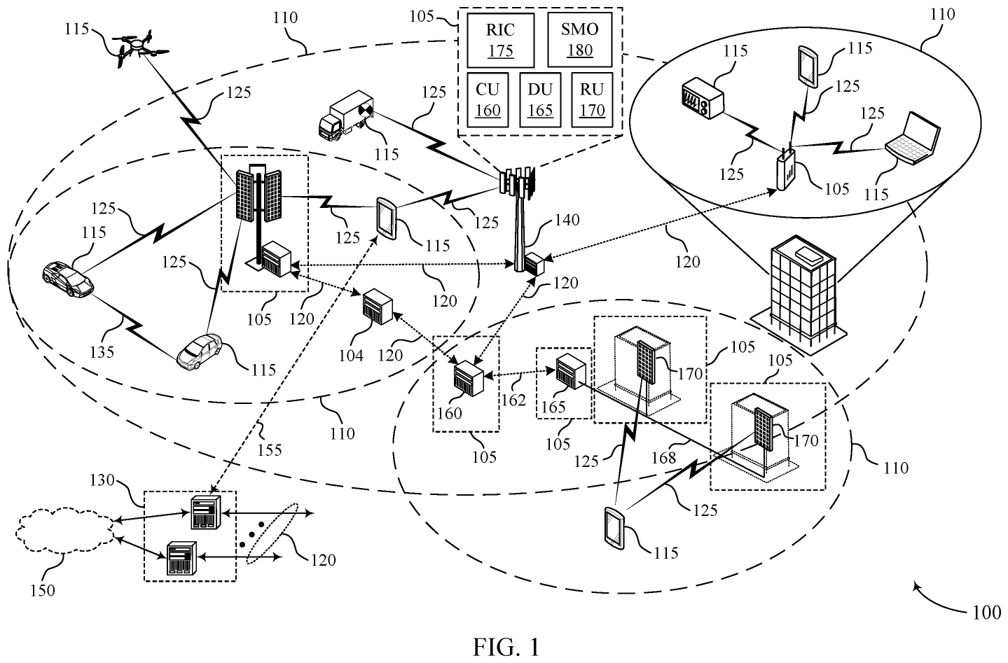

FIG. 1 illustrates an example of a wireless communications system 100 that supports a method for NR sidelink and LTE sidelink co-channel coexistence in accordance with one or more aspects of the present disclosure. The wireless communications system 100 may include one or more network entities 105, one or more UEs 115, and a core network 130. In some examples, the wireless communications system 100 may be an LTE network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support method for NR sidelink and LTE sidelink co-channel coexistence as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A 5G NR UE 115 may identify LTE channel occupancy by measuring CBR in a sidelink resource. A UE 115 may identify a pattern of resources, the pattern including a first set of resources dedicated for 5G NR (a second RAT) and a second set of resources dedicated for LTE (a first RAT). The UE 115 may perform a CBR measurement for a resource of the resource pattern (e.g., a slot of a slot pattern), and adjust the resource pattern based on the CBR measurement. The UE 115 may perform the CBR measurement on a resource dedicated for LTE, for example, to determine whether resources dedicated for LTE are being used. As another example, the UE 115 may perform a CBR measurement in a resource dedicated for 5G NR to determine if collisions are occurring on 5G NR resources. In some cases, the UE 115 may perform the CBR measurements on both dedicated LTE and 5G NR resources, and may adjust the resource pattern accordingly. The UE 115 may share the results of the CBR measurement and/or the adjusted resource pattern with other UEs 115 using sidelink inter-coordination messages, and accordingly, the other UEs 115 may also schedule 5G NR sidelink communications in resources with a low likelihood of collision with LTE communications.

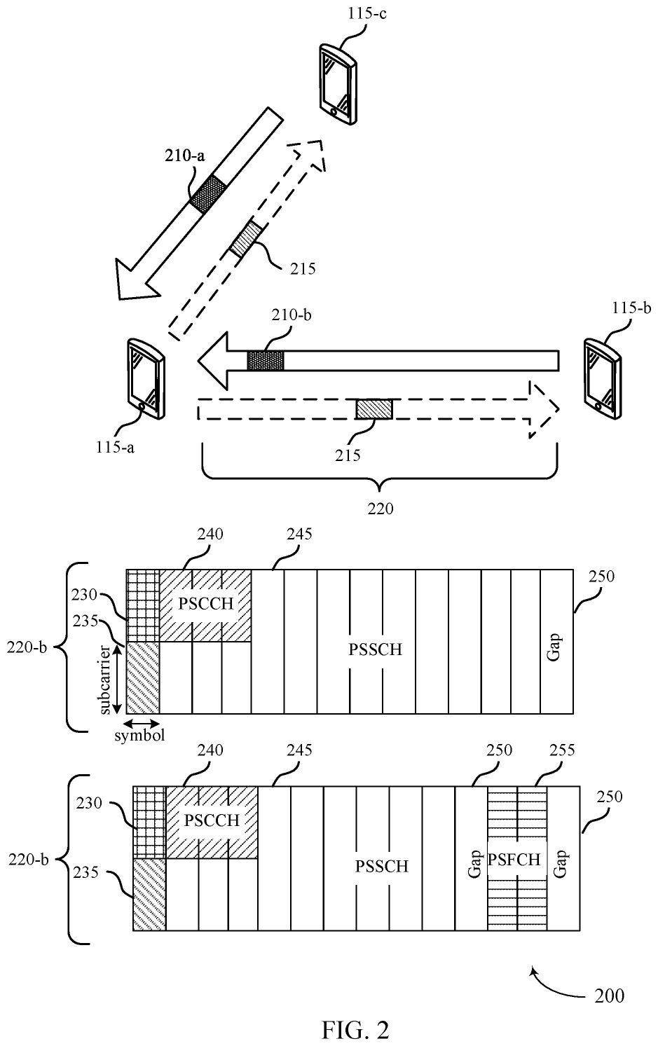

FIG. 2 illustrates an example of a wireless communications system 200 that supports a method for NR sidelink and LTE sidelink co-channel coexistence 115 in accordance with one or more aspects of the present disclosure. The wireless communications system 200 may implement aspects of or may be implemented by aspects of the wireless communications system 100. For example, the wireless communications system 200 includes a UE 115-a, a second UE 115-b, and a third UE 115-c, which may be examples of a UE 115 described with respect to FIG. 1. Although the co-channel coexistence techniques described herein are discussed with respect to determining and coordinating a slot pattern, the techniques may apply to any resource pattern associated with resources in a frequency domain and/or a time domain. For example, a UE 115 may determine an NR channel occupancy and/or an LTE channel occupancy with respect to a subchannel in the frequency domain, as well as with respect to a slot in the time domain (e.g., subchannel-slot pattern). Accordingly, as used herein, a “resource” refers to a frequency resource and/or a time resource. Although the coordination techniques described herein are discussed with respect to sidelink control information (SCI), other data container may be used for coordination, such as a MAC control element (MAC-CE) and the like.

In the wireless communication system 200, the first UE 115-a may receive a first sidelink control information (SCI) 210-a from the third UE 115-c and an SCI 210-b from the second UE 115-b. The UEs 115 may use inter-coordination, such as 3rd Generation Partnership Project (3GPP) Release 17 (Rel-17) inter-UE coordination framework to coordinate between the UEs 115. The UEs 115 may be NR devices 115 using NR technology (e.g., 5G NR devices using 5G NR). In some examples, based on monitoring for SCIs 210, the first UE 115-a may estimate an NR channel occupancy. Based on an estimated NR channel occupancy, the first UE 115-a may estimate (e.g., identify) a resource or slot pattern. For example, for a set of slots, first UE 115-a may identify a first subset of slots associated with NR communications and a second set of slots for LTE communications based on the estimated NR channel occupancy.

Accordingly, in some examples, NR and LTE may coexist, for example, on the same channel. In some examples, NR (e.g., NR V2X) and LTE (e.g., LTE V2X) may operate in the same channel due to limited resources (e.g., scarcity of spectrum). In the absence of any coordination mechanism, the NR transmission may collide with LTE transmission since the transmissions may occupy the same resources. The UEs 115 may provide inter-UE coordination messages using SCI 210-a and 210-b.

Both NR and LTE system performances may be degraded due to NR and LTE occupying the same resources. In some examples, an NR device (e.g., NR V2X device) may be a dual radio device, where the NR dual radio device can transmit basic safety messages (BSM) and cooperative awareness messages (CAM) packets in LTE V2X. The NR dual radio device may also transmit or share sensor data and other traffic on NR. Inter-coordination between NR devices may involve a set of available resources for a channel (e.g., resource pool frame structure). For the set of available resources, the NR may access or occupy the channel in a time slot while LTE may access or occupy the channel in another time slot. However, having the NR and LTE technologies and the UEs 115 in the network come to an agreement regarding occupancy of available resources for the channel, may be difficult. Accordingly, the set of available resources (e.g., the resource pool frame structure) may evolve over time as NR penetration rate increases. The set of available resources may also evolve based on changes in traffic over the NR or LTE. In some examples, changes may not be anticipated for the LTE procedures or modem.

Multiple NR and/or LTE device types may exist, such as type A devices that include both LTE sidelink and NR sidelink modules, type B devices that include NR sidelink modules, and type C devices that include LTE sidelink modules based on 3GPP Rel-14/Rel-15. There are multiple 3GPP release agreements for NR sidelink and LTE sidelink co-channel coexistence (e.g., 3GPP RAN-1 109-e). For co-channel coexistence in 3GPP Release 18 (Rel-18), the LTE sidelink specifications may not be changed. As such, for co-channel coexistence solutions in Rel-18, the combination of operational modes Mode 2 NR sidelink with Mode 4 LTE sidelink (e.g., Combination A) may be used. Some examples may include semi-static resource pool partitioning and dynamic resource sharing as for co-channel coexistence. In some examples, dynamic resource sharing may be used for co-channel coexistence. For a device type A, the NR sidelink module may use the sensing and resource reservation information shared by co-existing LTE sidelink module in the device. That is, device type A may include an NR module and an LTE module that may share information.

Although the following descriptions discuss techniques for type B and type C devices (e.g., UEs 115 that do not include both NR and LTE modules in a single device), the techniques may be used for other device types as well (e.g., type A and other devices). The UEs 115-a, 115-b, and 115-c may be NR devices that do not include both the NR and LTE module in a single device or do not include interfaces that may allow communication between NR and LTE modules in the single device. The UEs 115 may coordinate a set of NR transmission resources (e.g., occupied resources of the set of resources or the resource pool frame structure) using the Rel-17 inter-UE coordination. In some examples, a UE 115 (e.g., the first UE 115-a, the second UE 115-b, or the third UE 115-c) may signal the set of resources outside of the set of NR transmission resources as non-preferred resources.

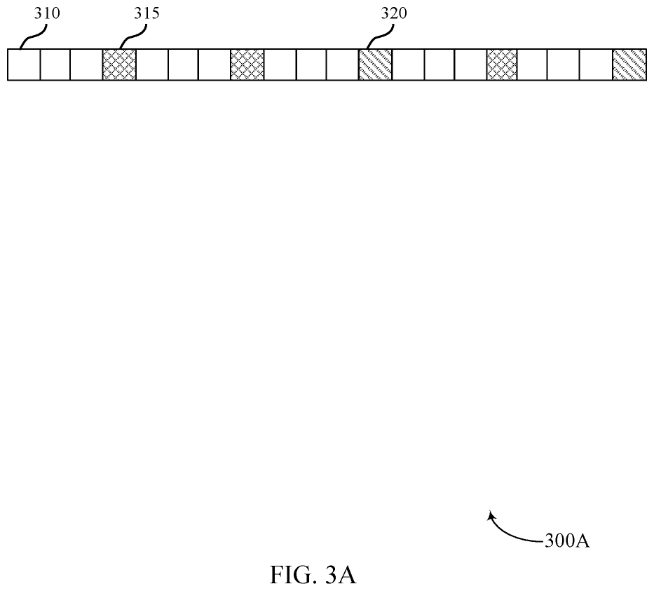

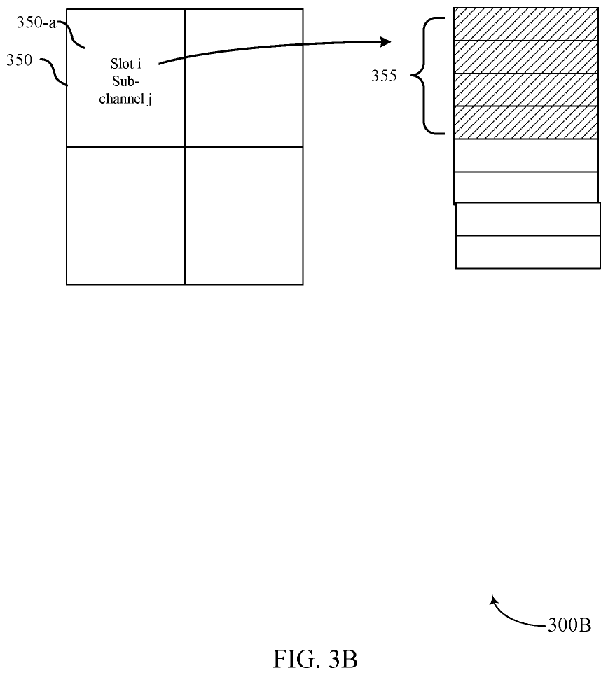

For example, in the network of NR UEs 115, the first UE 115-a may signal to the second UE 115-b via SCI 210-b and to the third UE 115-c via SCI 210-a, the resources that are non-preferred resources. These non-preferred resources may be occupied for LTE transmissions. The second UE 115-b and the third UE 115-c may not use these resources for transmission since they are non-preferred. That is, indication of some resources as non-preferred since they are resources used for LTE, may ensure that the NR UEs 115 in the network agree not to transmit on the LTE resources or non-preferred resources. In this manner, the UEs 115 may be synchronized in terms of the NR-LTE channel occupancy pattern to use, as discussed in detail with respect to FIG. 3A. Moreover, the UE 115-a providing this indication may efficiently convey the channel occupancy pattern without the second UE 115-b and the third UE 115-c having to perform techniques for determining which resources are occupied by LTE, especially if the second UE 115-b and the third UE 115-c (e.g., Rel-17 UEs) are incompatible for performing the techniques for determining occupancy.

The UEs 115 operating under Rel-17 may not be compatible with or support co-channel coexistence, but may be able to use a channel shared with LTE based on the inter-UE coordination techniques discussed herein. As discussed herein, the method for NR sidelink and LTE sidelink co-channel coexistence, may facilitate 3GPP Rel-18 NR sidelink UEs 115 and NR sidelink UEs 115 of earlier releases to be able to operate in the same resource pools, where resource pools can support type A, type B devices, and/or type C devices.

The UEs 115 may provide inter-UE coordination messages over SCI 210-a and SCI 210-b, in which the inter-UE coordination messages provide an indication of respective NR transmissions, resource occupancy for respective NR transmissions, slot occupancy, a determined channel occupancy pattern that may be a resource pattern or slot pattern, CBR measurements, and non-preferred resources. The SCI 210-a and the SCI 210-b may indicate whether the respective UEs 115 are able to perform a channel occupancy pattern determination and/or receive adjusted resource pattern 215 messages. The SCI 210-a and the SCI 210-b may also include channel access parameters associated with the resource occupancy. The channel access parameters may include, for example, parameters related to performing channel measurements to 0 determine LTE channel occupancy, NR channel occupancy, or both. The UEs 115 may perform inter-UE coordination and communicate the resource pattern with other UEs 115. For example, the first UE 115-a may communicate with the second UE 115-b and/or the third UE 115-c, a sidelink message in one of the NR slots (e.g., NR message or data message) indicating the adjusted resource pattern. The UEs 115 that perform resource occupancy determinations, such as the first UE 115-a, may transmit an indication of a resource pattern (e.g., a slot pattern), such as resource pattern or an adjusted resource pattern 215. As discussed with respect to FIG. 3A, an initial resource pattern may be adjusted based on CBR measurements.

The inter-UE coordination, including the SCI 210 and the resource pattern 215, may be transmitted between the UEs 115 using sidelink transmission resources. The sidelink transmission resources may include time domain resources (e.g., a slot 220 or a symbol) and frequency domain resources (e.g., a subcarrier frequency). An NR sidelink slot 220 may include 14 symbols. A first example of an NR sidelink slot 220-a may include a first subchannel 230 and a second subchannel 235 (e.g., frequency resource) of a channel that includes both the first subchannel 230 and the second subchannel 235. The first subchannel 230 may include a range of frequencies and the second subchannel 235 may include a second range of frequencies of the channel. In some examples, a single slot (e.g., time resource) may include both the first subchannel 230 and the second subchannel 235.

The smallest resource allocation unit may be a subchannel in frequency, such as the first subchannel 230 or the second subchannel 235. Resource allocation in time may include one slot, as shown. The first symbol of the NR sidelink slot 220 may be repeated on the preceding symbol, for example, for an automatic gain control (AGC) setting.

The first subchannel 230 may be allocated to physical sidelink control channel (PSCCH) 240 during 3 symbols (e.g., symbols 1, 2, and 3) and the second subchannel 235 may be allocated to a physical sidelink shared channel (PSSCH) 245 during those 3 symbols. In other symbols (e.g., symbols 4-12), both the subchannel 230 and the subchannel 235 may be allocated to PSSCH 245.

A gap resource 250 symbol may be present after the PSSCH allocation. The subchannel or subcarrier frequencies may include (e.g., be preconfigured with) multiple physical resource blocks (PRBs), such as 10, 12, 15, 20, 25, 50, 75, 100, and so forth, PRBs. The quantity of PSCCH RBs and OFDM symbols may include (e.g., be preconfigured with) one or more resource blocks (RBs). Feedback resources may be system-wide per a set of available resources for a channel (e.g., resource pool frame structure), where the set of available resources include or may be preconfigured with a period of N slots, where Nis a quantity of slots (e.g., 1 slot, 2 slots, 4 slots, and so forth). In some examples, the OFDM symbols may be occupied by the gap resource 250, the PSCCH, and/or a physical sidelink feedback channel (PSFCH). By way of example, three OFDM symbols may be occupied if the resources are configured for 1 gap 250 and two PSFCH symbols. The quantity of PRBs for the PSFCH may be preconfigured (e.g., bitmap of the resource allocation).

A second example of an NR sidelink slot 220-b may be transmitted using resources in the time domain and the frequency domain, as discussed with respect to the first sidelink transmission resources 220-a. In this example, some of the resource allocation may include PSFCH 255. For example, two symbols may be allocated to PSFCH 255. Gap resources 250 may precede a PSFCH allocation, as well as follow the PSFCH allocation. In some examples, the gap resource 250 may occupy resources between any channel occupancy changes, such between PSSCH and PSFCH. As discussed with respect to FIG. 3A, a resource occupancy may include an NR data slot 220-a including data resources (e.g., PSSCH 245) and control resources (e.g., PSCCH 240) for NR transmissions. The resource occupancy may also an include NR data, control, and feedback slot 220-b for NR transmissions, which include PSSCH 245, PSCCH 240, and PSFCH 250.

FIG. 3A illustrates an example of a resource occupancy diagram 300A that supports a method for NR sidelink and LTE sidelink co-channel coexistence in accordance with one or more aspects of the present disclosure. Although the following discussions describe the resource occupancy diagram 300A defined at a slot level, the resource element occupancy diagram 300A may be defined by any time domain level, such as a symbol-level, slot-level, or the like. The resource occupancy diagram 300A includes a pattern of slots that are occupied by LTE or NR.

As discussed with respect to FIG. 3A, an NR UE 115 may not include an LTE module in the same unit, device, or vehicle, or the NR UE 115 may include an LTE module but not include an interface between the NR and the LTE module (e.g., no LTE support). Due to the lack of LTE module or lack of LTE interfacing, the NR module may not be able to obtain sensing and slot reservation information from an LTE module. The NR UE 115 also may not be able to decode LTE control channel information. Thus, the NR UE 115 may coexist on a channel with LTE without having information regarding LTE channel occupancy (e.g., without having a “clear” knowledge of the LTE scheduling assignments).

In some examples, the NR UE 115 that does not have an LTE module or cannot interface with an LTE module may be a type B device. Accordingly, the NR device, which may be a type B device, may estimate LTE channel occupancy to facilitate NR and LTE coexistence while preventing or reducing LTE and NR interference (e.g., prevent or reduce system performance degradation). In this manner, the NR device may avoid LTE (e.g., avoid scheduling resources that collide with LTE communications) and coexist with other LTE devices transmitting over the same channel, in the absence of sensing information from a collocated LTE module or interfacing with an LTE module.

The resource occupancy diagram 300A may illustrate multiple slots forming a slot pattern. The slot pattern may include one or more LTE resource 310 (e.g., LTE only resource, excluded from the NR transmission resource set), one or more NR data and control resource 315 (e.g., NR PSSCH and PSCCH resource, included in NR transmission set), and one or more NR data, control, and feedback resource 320 (e.g., NR PSSCH and PSCCH with PSFCH, included in NR transmission set). The LTE resources 310 may be used for LTE transmissions, and the NR data and control resources 315 and the NR data, control, and feedback resources 320 may be used for NR transmissions.

In some examples, the NR UE 115 may receive or be configured with a default NR and/or LTE channel occupancy. In some examples, the NR UE 115 may estimate or identify an LTE resource occupancy (e.g., channel occupancy) or slot pattern, for example based on an estimated NR channel occupancy estimate (e.g., based on monitoring for SCIs). The LTE resource occupancy may be indicated by an LTE channel occupancy value. However, the LTE channel occupancy value may not match the actual LTE channel occupancy for the NR UE 115, which may be a type B device. Accordingly, the NR device may perform measurements to determine if the current LTE resource occupancy or LTE channel occupancy value is underestimating or overestimating the actual LTE channel occupancy. If the NR UE 115 is underestimating for the current LTE channel occupancy as determined based on the measurements, the NR UE 115 may increase the LTE channel occupancy value, decreasing the set of set of available NR transmission resources. However, if the NR device is overestimating the current LTE channel occupancy, the NR UE 115 may decrease the LTE channel occupancy value, increasing the set of available NR transmission resources.

To determine whether the current LTE channel occupancy value overestimates or underestimates the actual LTE channel occupancy, the NR UE 115 may measure CBR outside the set of available NR transmission resources or may measure CBR inside of the set of available NR transmission resources. Since the NR device knows which resources are used for NR transmission, the NR device may determine or predict which resources slots have LTE transmissions or are LTE resources 310 (e.g., slots that are not used for NR data and control resources 315 and the NR data, control, and feedback resources 320 are likely LTE resources 310 and can be used for measuring).

To measure the CBR, the NR device may measure CBR outside of the NR data and control resource 315 and the NR data (e.g., PSSCH 245 as shown in FIG. 2), control (e.g., PSCCH 240 as shown in FIG. 2), and feedback resource slots 320 (e.g., slots that include the PSFCH 255 as shown in FIG. 2). The NR device may compare measured CBR with CBR thresholds. If the measured CBR is lower than a first threshold, then the LTE may not fully occupy the remaining resources (e.g., resources that are not NR data and control resources 315 and the NR data (e.g., PSSCH 245 as shown in FIG. 2), control (e.g., PSCCH 240 as shown in FIG. 2), and feedback resources 320 (e.g., the PSFCH 255 as shown in FIG. 2)) as LTE resources 310. If the measured CBR is greater than the first threshold, then the current LTE channel occupancy as estimated by the NR UE 115 overestimates the LTE channel occupancy. Accordingly, the NR UE 115 may decrease the LTE channel occupancy value, increasing the set of available NR transmission resources. If the measured CBR is higher than a second threshold, then the LTE may be over occupying the remaining resources. That is, the current LTE channel occupancy as estimated by the NR UE 115 underestimates LTE channel occupancy, and thus, the NR UE 115 may increase the LTE channel occupancy value, decreasing the set of available NR transmission resources.

Since the NR UE 115 knows which resources are used for NR transmission, the NR UE 115 may also measure CBR inside of the NR resources or slots, such as NR data and control resources 315 (e.g., a slot 220-a as shown in FIG. 2) and the NR data, control, and feedback resources 320 (e.g., a slot 220-b as shown in FIG. 2). The NR UE 115 may compare measured CBR with CBR thresholds. In some examples, the CBR threshold for measuring inside the NR transmission resources may be different than the CBR threshold for measuring outside of the NR transmission resources. In some examples, the CBR thresholds may be the same.

If measured CBR is lower than a first threshold, the NR UE 115 may determine that NR does not fully occupy the available NR transmission resources (e.g., NR data and control resources 315 and the NR data, control, and feedback resources 320). That is, the current NR channel occupancy estimated by the NR UE 115 overestimates the actual NR channel occupancy, and thus, the NR usage is lower so that the NR UE 115 may increase the LTE channel occupancy value, decreasing the set of available NR transmission resources. If the measured CBR is greater than a second threshold, the NR UE 115 may determine that NR is occupying more than the available NR transmission resources (e.g., NR is underestimated in the NR channel occupancy estimated by the NR UE 115 and LTE occupancy in the LTE channel occupancy estimated by the NR UE 115 is over estimated), and thus, the NR device may decrease the LTE channel occupancy value, increasing the set of available NR transmission resources. By increasing or decreasing the LTE or NR resources, which may include increasing or decreasing the quantity of slots used for LTE or NR, respectively, the resource pattern may be adjusted (e.g., to an adjusted resource pattern).

FIG. 3B illustrates an example of sidelink feedback resources 300B that support a method for NR sidelink and LTE sidelink co-channel coexistence in accordance with one or more aspects of the present disclosure. Although the following discussions describe the sidelink feedback resources 300B at a slot level, the sidelink feedback resources 300B may be defined by any time domain level, such as a symbol-level, slot-level, or the like. In some examples, the sidelink feedback resources 300B may be defined at any frequency domain level. The sidelink feedback resources 300B include resources discussed with respect to FIG. 3A, and the resources may be occupied by LTE or NR.

The sidelink feedback resources 300 B may illustrate multiple resources 350 of a resource pattern such as slots of a slot pattern (e.g., resource occupancy 300A of FIG. 3A). A resource 350 may include a time resource and/or a frequency resource of the channel. For example, a first resource 350-a may include slot i, where i refers to a slot position in a sequence of a quantity of slots in a slot pattern, and the first resource 350-a may include a subchannel j, where j refers to a particular subchannel (e.g., range of frequencies or subcarrier frequency) of a channel. For example, the first resource 350-a may map to a set of resources 355 of a resource pattern (e.g., slot pattern). The one or more of the resources 350 of the set of resources 355 may be used for the PSFCH, such as for data, control, and feedback information. In some examples, the PSFCH may be enabled for unicast or groupcast transmissions. For unicast, the PSFCH may include 1 bit indicating a feedback of either an acknowledgement (ACK) or a negative acknowledgement (NACK). The PSSCH may map to the PSFCH resources based on one or more factors, including but not limited to, a starting subchannel of PSSCH, a slot including PSSCH, a source identification (ID), a destination identification (ID), a preconfigured minimum time gap k between a PSSCH slot and a PSFCH slot, where k refers to a time period. In some examples, a quantity of available PSFCH resources may be equal to or greater than a quantity of UEs 115 in a groupcast for the PSFCH.

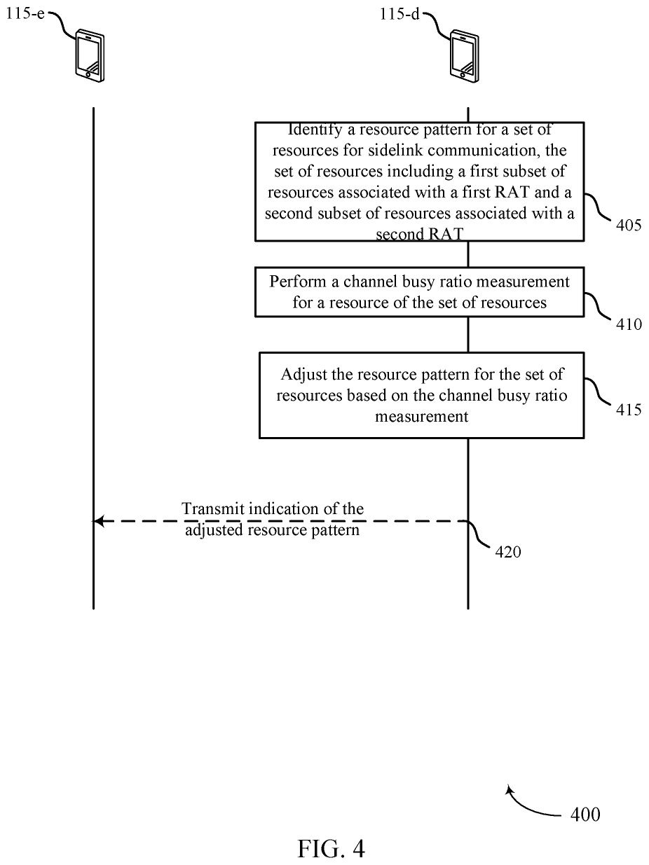

FIG. 4 illustrates an example of a process flow 400 that supports a method for NR sidelink and LTE sidelink co-channel coexistence 115 in accordance with one or more aspects of the present disclosure. The process flow 400 may implement aspects of or may be implemented by aspects of the wireless communications system 100 or the wireless communications system 200. For example, the process flow 400 may include a UE 115-d and a UE 115-e, which may be examples of a UE 115 as described herein. In the following description of the process flow 400, the operations performed by the UE 115-d and 115-e may be performed in different orders or at different times than the exemplary order shown. Some operations may also be omitted from the process flow 400, or other operations may be added to the process flow 400. Further, while operations in the process flow 400 are illustrated as being performed by the UE 115-d and the UE 115-e, the examples herein are not to be construed as limiting, as the described features may be associated with any quantity of different devices.

At 405, the UE 115-d may identify a resource pattern for a set of resources for sidelink communications, the set of resources including a first subset of resources associated with a first RAT and a second subset of resources associated with a second RAT. The first RAT may include LTE technology and the second RAT may include a 5G NR technology.

At 410, the UE 115-d may perform a CBR measurement for a resource of the set of resources, as discussed with respect to FIG. 3A. Performing the CBR measurement in a resource of the first subset of resources may be associated with the first RAT, such as LTE. In some examples, performing the CBR measurement in a resource of the second subset of resources may be associated with the second RAT, such as 5G NR. The UE 115-d may perform a second CBR measurement for a second resource of the set of resources, the second resource included within the second subset of resources associated with the second RAT, where the resource is included within the first subset of resources associated with the first radio access, and where adjusting the resource pattern further includes adjusting the resource pattern based on the second CBR measurement.

At 415, the UE 115-d may adjust the resource pattern for the set of resources based on the CBR measurement, as discussed with respect to FIG. 4. For example, the UE 115-d may adjust the resource pattern by increasing or decreasing the quantity of LTE resources or NR resources based on the CBR measurements. Adjusting the resource pattern may include adjusting a ratio of resources between the first subset of resources and the second subset of resources. In some examples, adjusting the resource pattern may include adjusting the resource pattern based at least in part on the CBR satisfying a threshold.

In some examples, at 420, the UE 115-d may transmit an indication of the adjusted resource pattern to the UE 115-e. For example, the UE 115-d may transmit, to another UE 115, a message that indicates the adjust resource pattern. In some examples, the threshold may be based on an amount of traffic associated with the second RAT. In some examples, the UE 115-d may communicate, with the UE 115-e, one or more sidelink messages in one or more resources of the second subset of resources using the second RAT in accordance with the adjusted resource pattern. In some examples, the UE 115-d may communicate, with the UE 115-e, a sidelink message in one of the second subset of resources using the second RAT in accordance with the adjusted resource pattern.

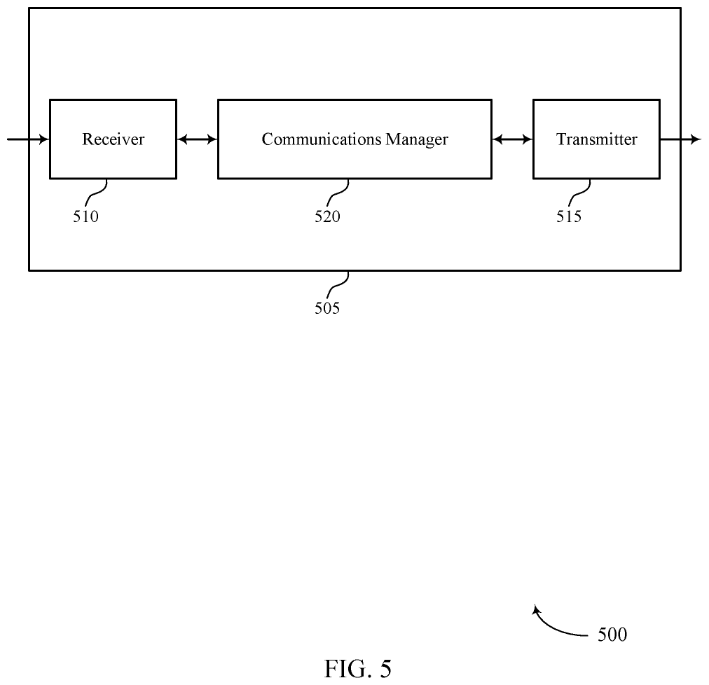

FIG. 5 illustrates a block diagram 500 of a device 505 that supports a method for NR sidelink and LTE sidelink co-channel coexistence in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to method for NR sidelink and LTE sidelink co-channel coexistence). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to method for NR sidelink and LTE sidelink co-channel coexistence). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of method for NR sidelink and LTE sidelink co-channel coexistence as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for identifying a resource pattern for a set of resources for sidelink communications, the set of resources including a first subset of resources associated with a first RAT and a second subset of resources associated with a second RAT. The communications manager 520 may be configured as or otherwise support a means for performing a CBR measurement for a resource of the set of resources. The communications manager 520 may be configured as or otherwise support a means for adjusting the resource pattern for the set of resources based on the CBR measurement.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for efficiently allocating resources for LTE and/or NR without LTE channel occupancy scheduling information, and while reducing or preventing LTE and NR system performance degradation.

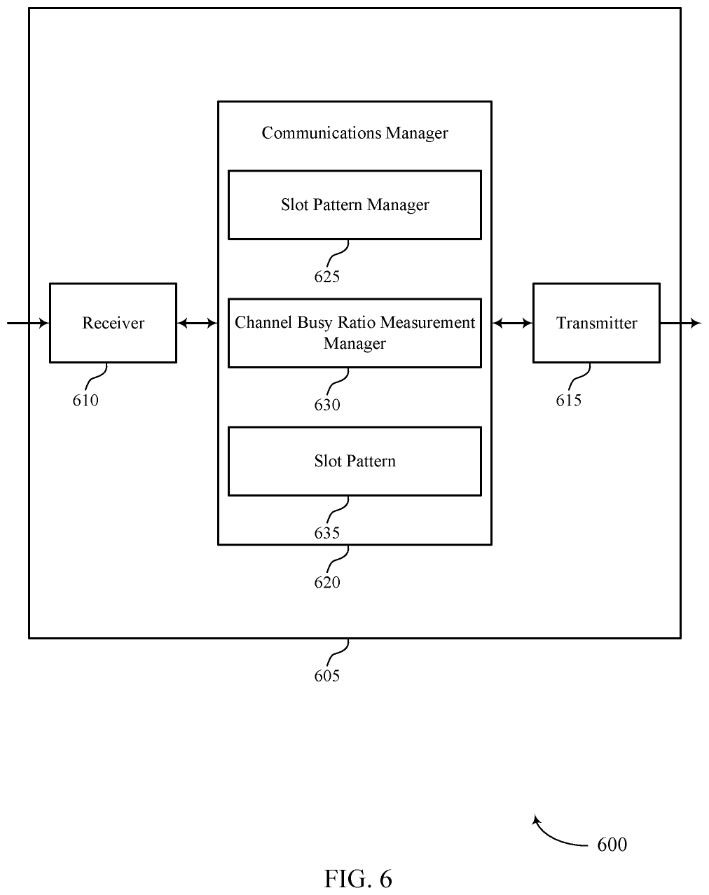

FIG. 6 illustrates a block diagram 600 of a device 605 that supports a method for NR sidelink and LTE sidelink co-channel coexistence in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to method for NR sidelink and LTE sidelink co-channel coexistence). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to method for NR sidelink and LTE sidelink co-channel coexistence). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of method for NR sidelink and LTE sidelink co-channel coexistence as described herein. For example, the communications manager 620 may include a resource pattern manager 625, a CBR measurement manager 630, a resource pattern 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The resource pattern manager 625 may be configured as or otherwise support a means for identifying a resource pattern for a set of resources for sidelink communications, the set of resources including a first subset of resources associated with a first RAT and a second subset of resources associated with a second RAT. The CBR measurement manager 630 may be configured as or otherwise support a means for performing a CBR measurement for a resource of the set of resources. The resource pattern 635 may be configured as or otherwise support a means for adjusting the resource pattern for the set of resources based on the CBR measurement.

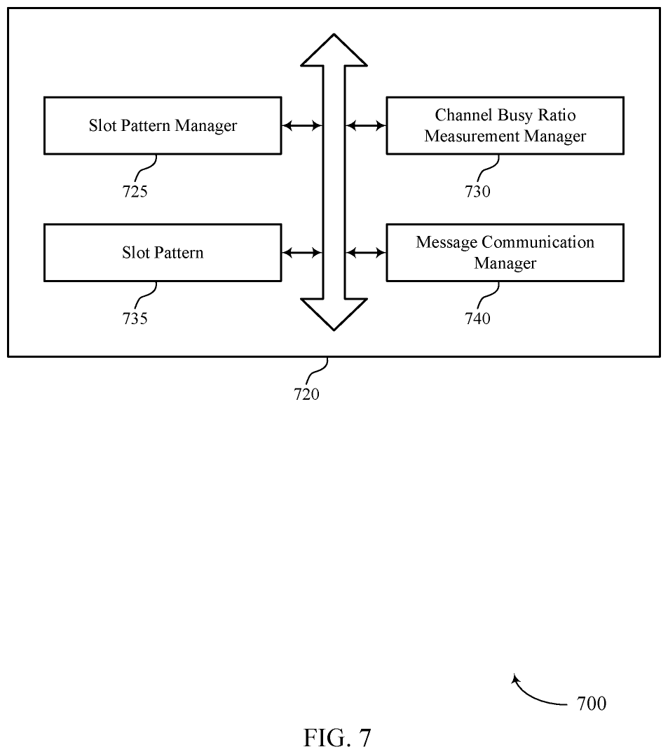

FIG. 7 illustrates a block diagram 700 of a communications manager 720 that supports a method for NR sidelink and LTE sidelink co-channel coexistence in accordance with one or more aspects of the present disclosure. The communications manager 720 may be an example of aspects of a communications manager 520, a communications manager 620, or both, as described herein. The communications manager 720, or various components thereof, may be an example of means for performing various aspects of method for NR sidelink and LTE sidelink co-channel coexistence as described herein. For example, the communications manager 720 may include a resource pattern manager 725, a CBR measurement manager 730, a resource pattern 735, a message communication manager 740, or any combination thereof. Each of these components may communicate, directly or indirectly, with one another (e.g., via one or more buses).

The communications manager 720 may support wireless communications at a UE in accordance with examples as disclosed herein. The resource pattern manager 725 may be configured as or otherwise support a means for identifying a resource pattern for a set of resources for sidelink communications, the set of resources including a first subset of resources associated with a first RAT and a second subset of resources associated with a second RAT. The CBR measurement manager 730 may be configured as or otherwise support a means for performing a CBR measurement for a resource of the set of resources. The resource pattern 735 may be configured as or otherwise support a means for adjusting the resource pattern for the set of resources based on the CBR measurement.

In some examples, the message communication manager 740 may be configured as or otherwise support a means for communicating, with a second UE, a sidelink message in one of the second subset of resources using the second RAT in accordance with the adjusted resource pattern.

In some examples, to support performing the CBR measurement, the CBR measurement manager 730 may be configured as or otherwise support a means for performing the CBR measurement in a resource of the first subset of resources associated with the first RAT.

In some examples, to support performing the CBR measurement, the CBR measurement manager 730 may be configured as or otherwise support a means for performing the CBR measurement in a resource of the second subset of resources associated with the second RAT. In some examples, a first CBR measurement may be performed on a first set of resources. Additional measurements may be performed for additional sets of resources (e.g., a second CBR measurement for a second set of resources, and so forth).

In some examples, the CBR measurement manager 730 may be configured as or otherwise support a means for performing a second CBR measurement for a second resource of the set of resources, the second resource included within the second subset of resources associated with the second RAT, where the resource is included within the first subset of resources associated with the first radio access, and where adjusting the resource pattern further includes adjusting the resource pattern based on the second CBR measurement.

In some examples, the first RAT is an LTE technology and the second RAT is a 5G NR technology.

In some examples, the message communication manager 740 may be configured as or otherwise support a means for transmitting, to a second UE, a message indicating the adjusted resource pattern.

In some examples, the message communication manager 740 may be configured as or otherwise support a means for communicating, with the second UE, one or more sidelink message in one or more resources of the second subset of resources using the second RAT in accordance with the adjusted resource pattern.

In some examples, to support adjusting the resource pattern, the resource pattern manager 725 may be configured as or otherwise support a means for adjusting a ratio of resources between the first subset of resources and the second subset of resources.

In some examples, to support adjusting the resource pattern, the resource pattern manager 725 may be configured as or otherwise support a means for adjusting the resource pattern based on the CBR satisfying a threshold.

In some examples, the resource pattern manager 725 may be configured as or otherwise support a means for determining the threshold based on an amount of traffic associated with the second RAT.

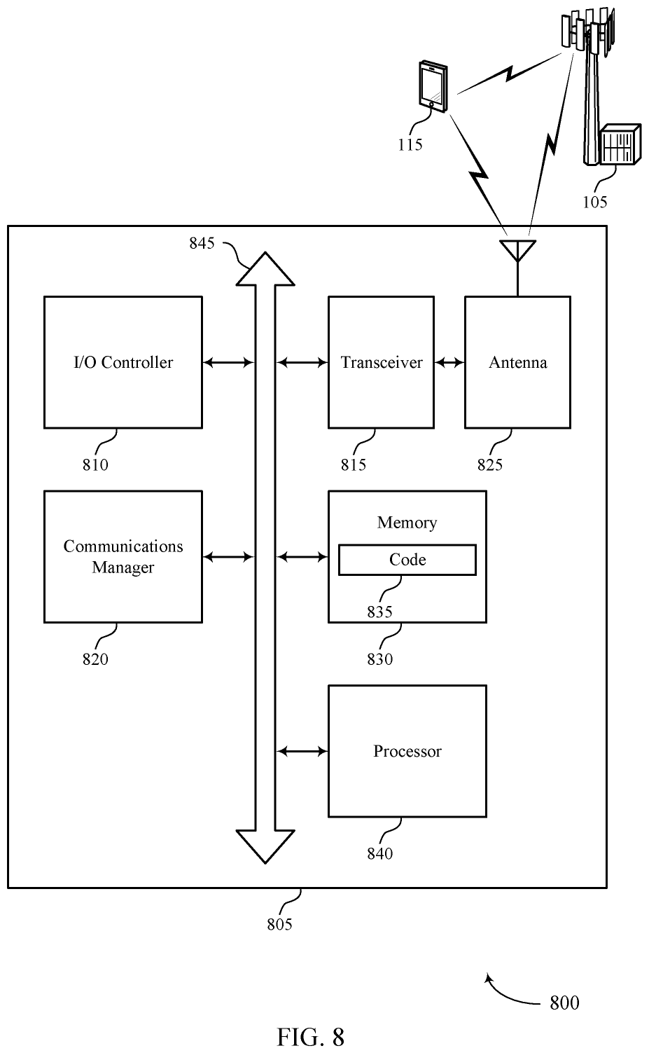

FIG. 8 illustrates a diagram of a system 800 including a device 805 that supports a method for NR sidelink and LTE sidelink co-channel coexistence in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting method for NR sidelink and LTE sidelink co-channel coexistence). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for identifying a resource pattern for a set of resources for sidelink communications, the set of resources including a first subset of resources associated with a first RAT and a second subset of resources associated with a second RAT. The communications manager 820 may be configured as or otherwise support a means for performing a CBR measurement for a resource of the set of resources. The communications manager 820 may be configured as or otherwise support a means for adjusting the resource pattern for the set of resources based on the CBR measurement.

By including or configuring the communications manager 820 in accordance with examples as described herein, the device 805 may support techniques for efficiently allocating resources for LTE and/or NR without LTE channel occupancy scheduling information, and while reducing or preventing LTE and NR system performance degradation.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of method for NR sidelink and LTE sidelink co-channel coexistence as described herein, or the processor 840 and the memory 830 may be otherwise configured to perform or support such operations.

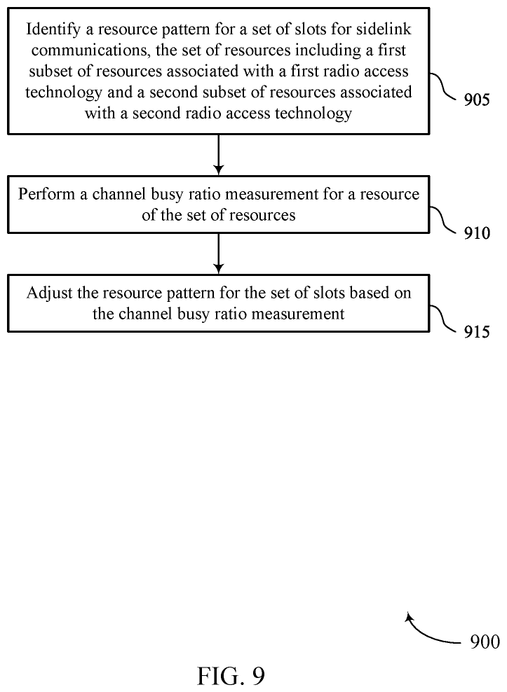

FIG. 9 illustrates a flowchart showing a method 900 that supports a method for NR sidelink and LTE sidelink co-channel coexistence in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include identifying a resource pattern for a set of resources for sidelink communications, the set of resources including a first subset of resources associated with a first RAT and a second subset of resources associated with a second RAT. The operations of 905 may be performed in accordance with examples as disclosed herein. In some examples, aspects of the operations of 905 may be performed by a resource pattern manager 725 as described with reference to FIG. 7.

At 910, the method may include performing a CBR measurement for a resource of the set of resources. The operations of 910 may be performed in accordance with examples as disclosed herein. In some examples, aspects of the operations of 910 may be performed by a CBR measurement manager 730 as described with reference to FIG. 7.

At 915, the method may include adjusting the resource pattern for the set of resources based on the CBR measurement. The operations of 915 may be performed in accordance with examples as disclosed herein. In some examples, aspects of the operations of 915 may be performed by a resource pattern 735 as described with reference to FIG. 7.

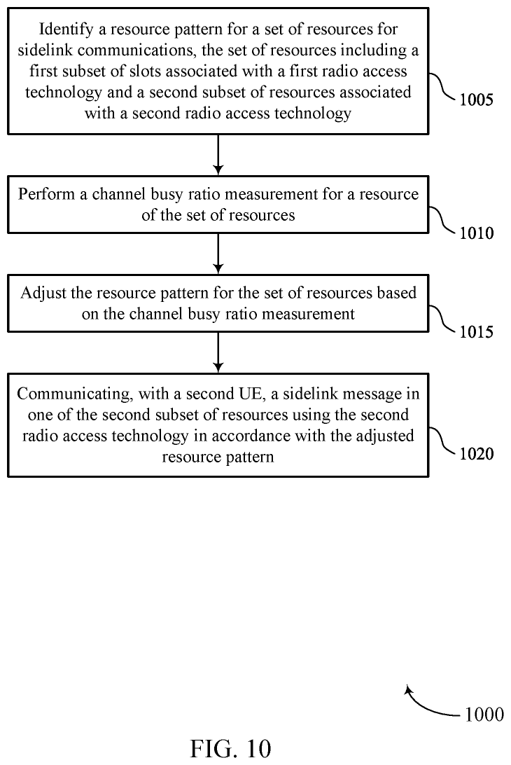

FIG. 10 illustrates a flowchart showing a method 1000 that supports a method for NR sidelink and LTE sidelink co-channel coexistence in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include identifying a resource pattern for a set of resources for sidelink communications, the set of resources including a first subset of resources associated with a first RAT and a second subset of resources associated with a second RAT. The operations of 1005 may be performed in accordance with examples as disclosed herein. In some examples, aspects of the operations of 1005 may be performed by a resource pattern manager 725 as described with reference to FIG. 7.

At 1010, the method may include performing a channel busy ratio measurement for a resource of the set of resources. The operations of 1010 may be performed in accordance with examples as disclosed herein. In some examples, aspects of the operations of 1010 may be performed by a CBR measurement manager 730 as described with reference to FIG. 7.

At 1015, the method may include adjusting the resource pattern for the set of resources based on the CBR measurement. The operations of 1015 may be performed in accordance with examples as disclosed herein. In some examples, aspects of the operations of 1015 may be performed by a resource pattern 735 as described with reference to FIG. 7.

At 1020, the method may include communicating, with a second UE, a sidelink message in one of the second subset of resources using the RAT in accordance with the adjusted resource pattern. The operations of 1020 may be performed in accordance with examples as disclosed herein. In some examples, aspects of the operations of 1020 may be performed by a message communication manager 740 as described with reference to FIG. 7.

The following provides an overview of aspects of the present disclosure:

Aspect 1: A method for wireless communications at a UE, comprising: identifying a resource pattern for a set of resources for sidelink communications, the set of resources comprising a first subset of resources associated with a first radio access technology and a second subset of resources associated with a second radio access technology; performing a channel busy ratio measurement for a resource of the set of resources; and adjusting the resource pattern for the set of resources based at least in part on the channel busy ratio measurement.

Aspect 2: The method of aspect 1, comprising: communicating, with a second UE, a sidelink message in one of the second subset of resources using the second radio access technology in accordance with the adjusted resource pattern.

Aspect 3: The method of any of aspects 1 through 2, wherein performing the channel busy ratio measurement comprises: performing the channel busy ratio measurement in a resource of the first subset of resources associated with the first radio access technology.

Aspect 4: The method of any of aspects 1 through 3, wherein performing the channel busy ratio measurement comprises: performing the channel busy ratio measurement in a resource of the second subset of resources associated with the second radio access technology.

Aspect 5: The method of any of aspects 1 through 4, further comprising: performing a second channel busy ratio measurement for a second resource of the set of resources, the second resource included within the second subset of resources associated with the second radio access technology, wherein the resource is included within the first subset of resources associated with the first radio access technology, and wherein adjusting the resource pattern further comprises adjusting the resource pattern based at least in part on the second channel busy ratio measurement.

Aspect 6: The method of any of aspects 1 through 5, wherein the first radio access technology comprises a long-term evolution (LTE) technology and the second radio access technology comprises a fifth generation new radio (5G NR) technology.

Aspect 7: The method of any of aspects 1 through 6, comprising: transmitting, to a second UE, a message indicating the adjusted resource pattern.

Aspect 8: The method of aspect 7, comprising: communicating, with the second UE, one or more sidelink messages in one or more resources of the second subset of resources using the second radio access technology in accordance with the adjusted resource pattern.

Aspect 9: The method of any of aspects 1 through 8, wherein adjusting the resource pattern comprises: adjusting a ratio of resources between the first subset of resources and the second subset of resources.

Aspect 10: The method of any of aspects 1 through 9, wherein adjusting the resource pattern comprises: adjusting the resource pattern based at least in part on the channel busy ratio measurement satisfying a threshold.

Aspect 11: The method of aspect 10, further comprising: determining the threshold based at least in part on an amount of traffic associated with the second radio access technology.

Aspect 12: An apparatus for wireless communications at a UE, comprising a processor; memory coupled with the processor; and instructions stored in the memory and executable by the processor to cause the apparatus to perform a method of any of aspects 1 through 11.

Aspect 13: An apparatus for wireless communications at a UE, comprising at least one means for performing a method of any of aspects 1 through 11.

Aspect 14: A non-transitory computer-readable medium storing code for wireless communications at a UE, the code comprising instructions executable by a processor to perform a method of any of aspects 1 through 11.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
identify a resource pattern for a set of resources for sidelink communications, the set of resources comprising a first subset of resources associated with a first radio access technology and a second subset of resources associated with a second radio access technology;
perform a channel busy ratio measurement for a slot of the set of resources; and
adjust the resource pattern for the set of resources based at least in part on the channel busy ratio measurement.

2. The apparatus of claim 1, wherein the instructions are further executable by the processor to cause the apparatus to:
communicate, with a second UE, a sidelink message in one of the second subset of resources using the second radio access technology in accordance with the adjusted resource pattern.

3. The apparatus of claim 1, wherein the instructions to perform the channel busy ratio measurement are executable by the processor to cause the apparatus to:
perform the channel busy ratio measurement in a resource of the first subset of resources associated with the first radio access technology.

4. The apparatus of claim 1, wherein the instructions to perform the channel busy ratio measurement are executable by the processor to cause the apparatus to:
perform the channel busy ratio measurement in a resource of the second subset of resources associated with the second radio access technology.

5. The apparatus of claim 1, wherein the instructions are further executable by the processor to cause the apparatus to:
perform a second channel busy ratio measurement for a second resource of the set of resources, the second resource included within the second subset of resources associated with the second radio access technology, wherein the resource is included within the first subset of resources associated with the first radio access technology, and wherein adjusting the resource pattern further comprises adjusting the resource pattern based at least in part on the second channel busy ratio measurement.

6. The apparatus of claim 1, wherein the first radio access technology comprises a long-term evolution (LTE) technology and the second radio access technology comprises a fifth generation new radio (5G NR) technology.

7. The apparatus of claim 1, wherein the instructions are further executable by the processor to cause the apparatus to:
transmit, to a second UE, a message indicating the adjusted resource pattern.

8. The apparatus of claim 7, wherein the instructions are further executable by the processor to cause the apparatus to:
communicate, with the second UE, one or more sidelink messages in one or more resources of the second subset of resources using the second radio access technology in accordance with the adjusted resource pattern.

9. The apparatus of claim 1, wherein the instructions to adjust the resource pattern are executable by the processor to cause the apparatus to:
adjust a ratio of resources between the first subset of resources and the second subset of resources.

10. The apparatus of claim 1, wherein the instructions to adjust the resource pattern are executable by the processor to cause the apparatus to:
adjust the resource pattern based at least in part on the channel busy ratio measurement satisfying a threshold.

11. The apparatus of claim 10, wherein the instructions are further executable by the processor to cause the apparatus to:
determine the threshold based at least in part on an amount of traffic associated with the second radio access technology.

12. A method for wireless communications at a user equipment (UE), comprising:
identifying a resource pattern for a set of resources for sidelink communications, the set of resources comprising a first subset of resources associated with a first radio access technology and a second subset of resources associated with a second radio access technology;
performing a channel busy ratio measurement for a resource of the set of resources; and
adjusting the resource pattern for the set of resources based at least in part on the channel busy ratio measurement.

13. The method of claim 12, comprising:
communicating, with a second UE, a sidelink message in one of the second subset of resources using the second radio access technology in accordance with the adjusted resource pattern.

14. The method of claim 12, wherein performing the channel busy ratio measurement comprises:
performing the channel busy ratio measurement in a resource of the first subset of resources associated with the first radio access technology.

15. The method of claim 12, wherein performing the channel busy ratio measurement comprises:
performing the channel busy ratio measurement in a resource of the second subset of resources associated with the second radio access technology.

16. The method of claim 12, further comprising:
performing a second channel busy ratio measurement for a second resource of the set of resources, the second resource included within the second subset of resources associated with the second radio access technology, wherein the resource is included within the first subset of resources associated with the first radio access technology, and wherein adjusting the resource pattern further comprises adjusting the resource pattern based at least in part on the second channel busy ratio measurement.

17. The method of claim 12, wherein the first radio access technology comprises a long-term evolution (LTE) technology and the second radio access technology comprises a fifth generation new radio (5G NR) technology.

18. The method of claim 12, comprising:
transmitting, to a second UE, a message indicating the adjusted resource pattern.

19. The method of claim 18, comprising:
communicating, with the second UE, one or more sidelink messages in one or more resources of the second subset of resources using the second radio access technology in accordance with the adjusted resource pattern.

20. The method of claim 12, wherein adjusting the resource pattern comprises:
adjusting a ratio of resources between the first subset of resources and the second subset of resources.

21. The method of claim 12, wherein adjusting the resource pattern comprises:
adjusting the resource pattern based at least in part on the channel busy ratio measurement satisfying a threshold.

22. The method of claim 21, further comprising:
determining the threshold based at least in part on an amount of traffic associated with the second radio access technology.

23. An apparatus for wireless communications at a user equipment (UE), comprising:
means for identifying a resource pattern for a set of resources for sidelink communications, the set of resources comprising a first subset of resources associated with a first radio access technology and a second subset of resources associated with a second radio access technology;
means for performing a channel busy ratio measurement for a resource of the set of resources; and
means for adjusting the resource pattern for the set of resources based at least in part on the channel busy ratio measurement.

24. The apparatus of claim 23, further comprising:
means for communicating, with a second UE, a sidelink message in one of the second subset of resources using the second radio access technology in accordance with the adjusted resource pattern.

25. The apparatus of claim 23, wherein the means for performing the channel busy ratio measurement comprise:
means for performing the channel busy ratio measurement in a resource of the first subset of resources associated with the first radio access technology.

26. The apparatus of claim 23, wherein the means for performing the channel busy ratio measurement comprise:
means for performing the channel busy ratio measurement in a resource of the second subset of resources associated with the second radio access technology.

27. The apparatus of claim 23, further comprising:
means for performing a second channel busy ratio measurement for a second resource of the set of resources, the second resource included within the second subset of resources associated with the second radio access technology, wherein the resource is included within the first subset of resources associated with the first radio access technology, and wherein adjusting the resource pattern further comprises adjusting the resource pattern based at least in part on the second channel busy ratio measurement.

28. The apparatus of claim 23, wherein the first radio access technology comprises a long-term evolution (LTE) technology and the second radio access technology comprises a fifth generation new radio (5G NR) technology.

29. The apparatus of claim 23, further comprising:
means for transmitting, to a second UE, a message indicating the adjusted resource pattern.

30. A non-transitory computer-readable medium storing code for wireless communications at a user equipment (UE), the code comprising instructions executable by a processor to:
identify a resource pattern for a set of resources for sidelink communications, the set of resources comprising a first subset of resources associated with a first radio access technology and a second subset of resources associated with a second radio access technology;
perform a channel busy ratio measurement for a resource of the set of resources; and
adjust the resource pattern for the set of resources based at least in part on the channel busy ratio measurement.
